(19) United States
(12) Patent Application Publication
(10) Pub. No.: US 2009/0220471 A1
(43) Pub. Date: Sep. 3, 2009

(54) Solution for the biological cleaning of toothbrushes and corresponding device

(76) Inventor: Cornelis Gielen, Overpelt (BE)

Correspondence Address: CRUYSBERGHS RUDI, HAACHTSESTEENWEG 1369, BRUSSELS (HAREN), 1130, BE

(21) Appl. No.: 12/379,478

(22) Filed: Feb. 23, 2009

(30) Foreign Application Priority Data
Feb. 28, 2008 (BE) BE/2008/0117

(51) Int. Cl. A01N 63/00; A01P 1/00

(52) U.S. Cl. 424/93.46

(57) ABSTRACT

A solution for the cleaning of toothbrushes consisting of a watery solution with a mixture of non-pathogenic gram-positive bacteria of the Bacillus genus, whereby the enzymatic action decomposes any food particles remaining between the hairs of a toothbrush, and a receptacle, possibly with several compartments, for the introduction of the solution, in which the toothbrush is submerged.

The present invention concerns a solution of non-pathogenic bacteria to clean toothbrushes. In particular, it concerns a selection of gram-positive bacteria of the Bacillus genus.

In addition, the invention concerns a corresponding device consisting of a receptacle containing the solution, in which the toothbrush is treated.

After brushing one's teeth, small food particles remain between the hairs of a toothbrush. This is inevitable even when frequently rinsing with water. Since the hairs of a toothbrush are usually planted group-wise in the head, they are very close to one another. Due to this construction method, a variety of food particles become lodged between the hairs. In turn, these food particles are a breeding ground for various harmful bacteria, which may result in contamination and possibly dental decay and infections.

Various prior art technologies have already been developed to disinfect toothbrushes after use.

A first possible technology uses ultrasonic vibrations. Such an application is described for instance in WO2007071031.

Another known technology uses hot air, as described in US2004033182 or steam as described in GB2336313.

The use of microwaves, in combination with a germicide, hydrogen peroxide and/or formaldehyde is described in DE19957924.

US2007295916 describes the use of UV radiation to disinfect toothbrushes.

The use of atmospheric pressure plasma is known from KR20040037907.

The use of chemical substances to disinfect toothbrushes is known from U.S. Pat. No. 6,675,425, according to which a photocatalytic material is used. WO2005016100 uses a disinfecting liquid.

WO0100250 describes a technology according to which a gas, such as ozone, is developed for the purpose of disinfection.

The use of microorganisms to disinfect for instance toothbrushes is known from WO2007053581. The gallium (III) ion is used thereby, in combination with probiotic, non-pathogenic microorganisms of the Lactobacillus genus, such as Lactobacillus acidophilus, Lactobacillus plantarum, Lactobacillus leichmannii, Lactobacillus johnsonni or Lactobacillus delbrueckii.

The above-mentioned technologies are all aimed at disinfecting the toothbrush or, in other words, eliminating any potentially harmful pathogenic bacteria.

The use of low-degradable detergents or other environmentally hazardous agents are a drawback.

In addition, the drawback of some of these devices is that they use a relatively complex apparatus, powered by a corresponding energy source.

Domestically, for instance in a kitchen or bathroom, such apparatuses take up significant space and do not provide optimum user-friendliness for children.

On the other hand, it is also known from EP1429808 to use Bacillus Clausii, including a non-soluble absorbing medium in H₂O with a cellulose derivative, for pharmaceutical, veterinary and/or food purposes.

However, our invention is aimed at finding a solution for the above-mentioned disadvantages by means of a mixture of non-pathogenic bacteria, whereby the enzymatic decomposition of any food particles remaining between the hairs of toothbrushes is achieved, as well as a corresponding receptacle in which the toothbrush, after having been used, is placed in a solution of such bacteria.

The use of receptacles with multiple compartments, in which several toothbrushes can be placed in a solution after use, is known from the prior art. However, such receptacles are mainly used with detergents or chemical solutions for a disinfecting effect.

In other words, our invention consists of a biological mixture of non-pathogenic gram-positive bacteria of the Bacillus genus, both as a ready-made solution and as a powder which needs to be dissolved, introduced in a corresponding receptacle. In addition, the non-pathogenic bacteria can occur as spores.

The receptacle can consist of various compartments to place several toothbrushes in separately.

This solution can be introduced in the receptacle's compartments prior to its use or can be provided as a ready-made kit with an appropriate packaging.

Consequently, the first advantage of this invention is that no harmful, environmentally hazardous or polluting substances are used. Our invention consists of a biological mixture, with the enzymatic action of the non-pathogenic gram-positive bacteria as a primary objective. The enzymatic action of e.g. Bacillus megaterium is known from WO02094181, whereby fats and fatty acids are decomposed by lipases.

Another advantage is that no complex or energy-rich disinfecting devices are used, but a simple receptacle, with several compartments or otherwise. This stimulates children to prevent dental decay in a simple and educational manner.

Our invention also has the advantage that the unit can be provided as a kit. The non-pathogenic bacteria of the Bacillus genus can be provided both as a powder and as a prepared solution, together with a corresponding kit-type receptacle. For instance, this can consist of a biodegradable receptacle containing the corresponding solution for single use.

The invention is detailed below.

The biological mixture consists of a selection of non-pathogenic gram-positive bacteria of the Bacillus genus.

A first group consists of the Bacillus subtilis. These bacteria are known for the subtilisin enzyme, which decomposes proteins. The proteolytic effect plays an important role in the enzymatic decomposition.

Another group is Bacillus amyloliquefaciens, which contains the amylase enzyme and which ensures the hydrolysis of amylum. These bacteria are also known for the subtilisin enzyme.

A third group consists of Bacillus licheniformis. This strain also belongs to the subtilisin group. These bacteria are characterised by their protease- en amylase-based action.

Subtilisin is a hydrolase and particularly a serine protease having a proteolytic effect. In addition, this enzyme is a high-alkaline protease. Its effect is known from Harwood, C.R. (1992), Bacillus subtilis and its relatives, molecular biological and industrial workhorses, Trends Biotechnol 10, 247-256 en Wells, J. A & Estell D. A. (1988), Subtilisin—an enzyme designed to be engineered, Trends Biochem Sci 13, 291-297.

Bacillus Pumilis is another group and is characterised for instance by its lipase.

Finally, there is Bacillus megaterium which is also known for the decomposition of fats by lipases.

The bacterial strains are preferably mixed in a watery solution. Furthermore, in accordance with a specific method, the invention concerns a mixture of the above-mentioned non-pathogenic gram-positive bacteria in the form of spores.

The solution is introduced in a receptacle, in which toothbrushes are treated after use. The hairs of a toothbrush are submerged in the bacterial solution. Due to the enzymatic action of for instance the proteases, amylases and lipases, any food particles located between the hairs are decomposed.

Domestically, various toothbrushes tend to be used. The receptacle consists of a similar method with multiple compartments, in which the various toothbrushes are placed separately. The receptacle is preferably made of plastic.

According to a possible method, the receptacle is modular, whereby compartments can be added or removed. By means of a fastener, such as a clip system, compartments can be added, depending on the number of family members. In addition, the receptacle's configuration can be changed. The compartments can be attached next to each other, in line or in a ring-shaped structure for instance. With this device, the user can be identified on the receptacle, for instance with a colour or a symbol.

The solution is preferably refreshed every 5 days.

According to another possible method, the solution and the receptacle are provided as a kit. The solution is introduced in the receptacle and provided with the sealed packaging. The receptacle can be made of a biodegradable material. This method makes the device suited for single use.

The solution can also be packed in packaging with a dosing system, such as pump. Using this method, an exact dose is always dispensed. The solution can also be dispensed as a higher concentrate, allowing a liquid to be added when using it.

1. Solution for the cleaning of toothbrushes, consisting of a mix of non-pathogenic gram-positive bacteria and characterised by the fact that the bacteria consist of a selection of the Bacillus genus.

2. Solution for the cleaning of toothbrushes according to claim 1 and characterised by the fact that the mixture consists of Bacillus subtilis, Bacillus amyloliquefaciens, Bacillus licheniformis, Bacillus pumilis and Bacillus megaterium.

3. Solution for the cleaning of toothbrushes according to claims 1-2 and characterised by the fact that the bacteria occur in the form of spores in the mixture.

4. Solution for the cleaning of toothbrushes according to claims 1-3 and characterised by the fact that the mixture consists of a watery solution.

5. Solution for the cleaning of toothbrushes according to the previous claims and characterised by the fact that the solution is introduced in a receptacle, whereby the hairs of a toothbrush are submerged.

6. Solution for the cleaning of toothbrushes according to claim 5 and characterised by the fact that the receptacle consists of several compartments.

7. Solution for the cleaning of toothbrushes according to claim 6 and characterised by the fact that the receptacle is modular, whereby the compartments can be connected to each other in a desired configuration, using a fastener.

8. Solution for the cleaning of toothbrushes according to claims 1-7 and characterized by the fact that the solution is provided in a packaging with a dosing system such as a pump system.

9. Solution for the cleaning of toothbrushes according to claims 1-8 and characterised by the fact that the solution is packed in a concentrated form.

10. Solution for the cleaning of toothbrushes according to claims 1-9 and characterised by the fact that the solution and the receptacle are provided as a kit.
